(19) United States
(12) Patent Application Publication
(10) Pub. No.: US 2011/0055145 A1
(43) Pub. Date: Mar. 3, 2011

(54) Method and apparatus for insightful dimensional clustering

(76) Inventors: Eric A. Johnson, Longmont, CO (US); Don Kainer, Longmont, CO (US); Adrian Fan, Longmont, CO (US)

(21) Appl. No.: 12/799,217

(22) Filed: Apr. 19, 2010

Related U.S. Application Data
(60) Provisional application No. 61/170,213, filed on Apr. 17, 2009.

(51) Int. Cl. G06N 5/02

(52) U.S. Cl. 706/54

(57) ABSTRACT

An Insightful Dimensional Clustering (IDC) application is disclosed. The insightful dimensional clustering engine may perform various functions, including, performing an iterative process to determine the identity of dimensions that are important to the tag and the identity of the segment of a population having a target behavior, segmenting the population within the data space into clusters, analyzing the resulting clusters for a high tag concentration, and displaying the resulting clusters to name a few. The insightful dimensional clustering engine may be implemented as one or more processes operating on a computer or server, or may be a specially adapted computer or hardware device configured to perform the one or more operations described herein.

### RELATED APPLICATIONS

This applications claims priority from U.S. Provisional Application No. 61/170,213, filed Apr. 17, 2009, which is hereby incorporated by reference.

### FIELD OF THE INVENTION

Clustering algorithms are useful tools which provide segmentation and grouping in a wide variety of domains amongst an extensive variance of dimensions. Clustering is commonly used for segmentation analysis in fields such as marketing research and data mining to divide populations of customers into market segments.

### BACKGROUND

The general form of clustering algorithms perform in dimensions with various initial conditions, while optimizing some distance measure to gain insight into the nature of the data. Clustering algorithms find segmentations and complete when an optimal convergence is achieved. Convergence is usually determined when clusters change very little from iteration to iteration. The standard types of clustering have many challenges, however, such as selection of initial conditions, the optimal distance measure, and the dimensions in which to cluster.

### BRIEF SUMMARY

The present invention provides a computer-implemented method for identifying a segment of a population having a target behavior within a larger population within a data space using insights obtained from a population having known behavior using a clustering algorithm. In general, the method includes identifying a plurality of dimensions to be used in the clustering algorithm and thereafter narrowing the number of dimensions to be used in the clustering algorithm from a plurality of dimensions to a set of initial dimensions based upon analytics from various sources. The tag is defined from target behavior data within the data space from the population having a known behavior. The tag is then refined based upon insights from the larger population within a data space. The population within the data space is segmented into clusters using the clustering algorithm. The resulting clusters are analyzed for a high tag concentration. The resulting clusters are then displayed.

### BRIEF DESCRIPTION OF THE DRAWINGS

FIG. 1 illustrates a block diagram of a computing system for identifying a segment of a population having a target behavior within a larger population within a data space using insights obtained from a population having known behavior;

FIG. 2 illustrates the insightful dimensional clustering process;

FIG. 3 shows an example of using insights to select the initial dimensions for clustering;

FIG. 4 shows an example of dimension analysis to determine cluster variance; and

FIG. 5 illustrates one example of hot spot analysis of clusters with a high churner concentration.

### BRIEF DESCRIPTION

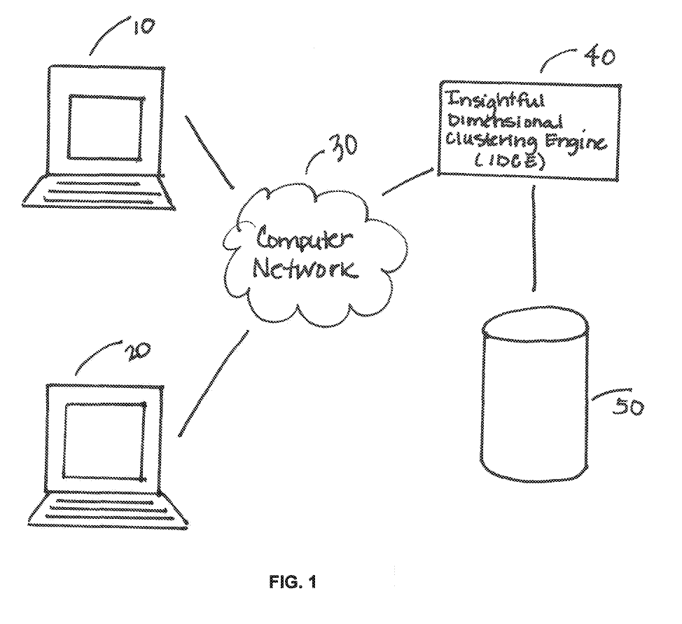

FIG. 1 illustrates an example block diagram of a computing system for providing a segmentation analysis based upon a clustering algorithm in accordance with the present invention. Various computer generated displays of high tag concentrations can be created and displayed to a user with respect to various issues relating to identifying a segment of a population having a target behavior within a larger population of a data space using insights obtained from a population having known behavior using a clustering algorithm—such as but not limited to, identifying a plurality of dimensions to be used in the clustering algorithm; narrowing the number of dimensions to be used in the clustering algorithm from a plurality of dimensions to a set of initial dimensions based upon analytics from various sources; defining a tag from target behavior data within the data space from the population having a known behavior; refining a tag based upon insights from the larger population within a data space; segmenting the population within the data space into clusters using a clustering algorithm; analyzing the resulting clusters for a high tag concentration; and displaying the resulting clusters.

As shown in FIG. 1, the system may include one or more terminals 10, 20 communicatively coupled over a network 30 to an insightful dimensional clustering engine 40. One or more databases 50 can be used to store and make available information such as flags, dimensions, analytics and transactional variables. The databases can be implemented using conventional database technology, including local databases, networked storage devices, or other conventional technologies.

The insightful dimensional clustering engine 40 may perform various functions described herein, including performing an iterative process to determine the identity of dimensions that are important to the tag and the identity of the segment of a population having a target behavior, segmenting the population within the data space into clusters, analyzing the resulting clusters for a high tag concentration, and displaying the resulting clusters to name a few. The insightful dimensional clustering engine 40 may be implemented as one or more processes operating on a computer or server, or may be a specially adapted computer or hardware device configured to perform the one or more operations described herein. The insightful dimensional clustering engine 40 can include a program, applet or graphical user interface to gather information from users, receive commands, and provide displays of results to users.

In one example, using a clustering algorithm in conjunction with the insightful dimensional clustering engine 40, the computer implemented method of the present invention identifies one or more customers having a target behavior within a larger population of customers within a telecommunication carrier data space using insights obtained from customers having known behavior. One or more variables related to identifying a plurality of dimensions to be used in the clustering algorithm from a plurality of transactional variables within a transactional database and defining a tag from the customers having a known behavior may be stored, either temporarily or permanently, in a database accessible by (or data made available to) the insightful dimensional clustering engine 40. The insightful dimensional clustering engine 40 can then segment the population of customers within the data space into clusters using the clustering algorithm, analyze the resulting clusters for a high tag concentration so as to identify dimensions having a defined variance to the tag, and display the resulting clusters.

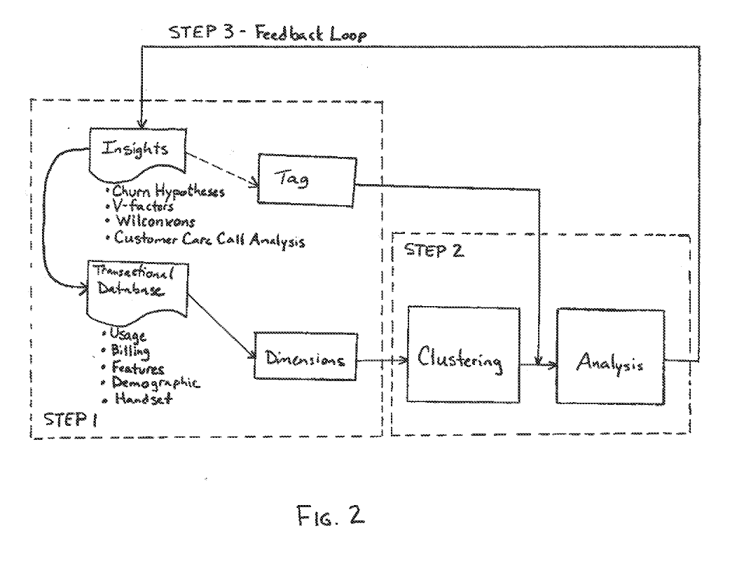

FIG. 2 depicts one embodiment of the IDC process in detail. As shown, in the first stage of IDC, a user contributes insightful narrowing of the dimensions which to cluster on based on analytics from various sources (e.g., V-factors, speech data, reports, or familiarity with the data). Thus, the vast space of dimensions to cluster on is narrowed to a few specific dimensions (in a transactional database for example). The tag is then defined by a target behavior within the data space from a population having a known behavior. In one example, the behavior may be the troublesome phenomenon in the subscriber base, such as a churn propensity flag. The tag can be refined by other insights, such as customers with a churn flag and that have called customer care for a particular complaint.

In the illustrated example, the second stage of the process uses a clustering algorithm to segment the population. The subsequent divisions vary in the concentration of the defined tag. The IDC process uses a naive k-nearest neighbor algorithm, an extremely robust clustering algorithm that has been well documented throughout machine learning literature. The process uses random initial points and repetition to ensure robustness. The distance metric is either a weighted Euclidean distance or normalized dimensions to prevent skewing. Generally, very little is done to alter the distance metric to achieve proper clusters. Changes in the weights usually produce similar clusters. The dimensions that are clustered on use units of a similar order (monetary, time, etc.). If units must be crossed, there is usually an insight that aids in balancing these dimensions, which is considered in the first step of the process (for example: 500 minutes is approximately $5 on a rate plan).

As stated previously, the insightful dimensional clustering engine 40 runs the clustering algorithm. During clustering (i.e., the second stage of the process), the present invention optimizes the following equation and minimizes the distance from all points to each cluster's center:

$${arg min}_{s} {\sum }_{i = 1}^{k} {\sum }_{{x}_{j} ∈ {S}_{i}} {\vert {x}_{j} - {μ}_{i} \vert}^{2}$$

where μᵢ is the mean of Sᵢ

arg min=find the minimum argument which satisfies . . . (basically, find the best fit)

S=The set of points which create 1 Cluster; is composed of many x

u=the mean of the cluster (i.e., its center)

x=one of our data points

k=the number of total clusters allowed (chosen at beginning)

There are ‘k’ cluster points. What this equation demonstrates is that by minimizing and resorting to cluster centers, the invention will find centers with the smallest Euclidean distance to the most amount of points.

During the third stage of the process shown in FIG. 2, the user analyzes the clusters for high tag concentration, referred to as hot spot analysis. Upon analysis, the process is repeated by either eliminating dimensions which were not significant in the hot spot analysis, refining the tag to be more specific, or refining the tag to be more general. The iterative process provides information on which dimensions are important to a chosen tag and which segments of the population contain these abnormal tag concentrations.

The following equation is a standard variance measure that the present invention uses during hot spot analysis (third stage of the process):

$${s}_{N} = \sqrt{\frac{1}{N} {\sum }_{i = 1}^{N} {( {x}_{i} - \overline{x} )}^{2}}$$

N=the top few entries, after sorting by tag concentration that have meaning

X with bar=The mean of that dimension

Xᵢ=a given point in our data set

There is the assumption that this measure is only looking at one dimension of data. In this case, the present invention is calculating S_{N} which is the variance of the final cluster centers. X with a bar over it represents the mean of the cluster centers, with Xᵢ representing each cluster center. The present invention searches through the first N relevant clusters (e.g., sort by highest tag concentration and march down the first 10-20 or so) and calculate S_{N}. After calculation, the ratio of S_{N} versus X with a bar is our final measure to determine whether a dimension was relevant or not.

Since the tag is representative of a target behavior in the customer population, IDC identifies specific segments of the population with abnormally high target behavior. Customers within defined clusters that have not yet displayed tag behavior are then acted on, as they are more likely to display the tag behavior in the future. Thus, insights from customers with known behaviors and propensities are extended to customers that have not yet displayed these behaviors.

The following is one particular example of the present invention describing the IDC process specific to the telecommunications industry. One skilled in the art will recognize that the IDC process is not specific to the telecommunications industry and could be extended to any number of industries similar in breadth and scope. A telecommunications provider has several forms of data available including billing, payment, usage, features, customer care tickets, and demographic data aggregated in a data warehouse for analysis. The IDC segments the customer base into groups with similar behaviors and preferences (dimensions) and then analyze which clusters have a high concentration of churners (tag concentration). The IDC process is applicable to the telecommunications industry because the dimensions can be obtained from known fields in a transactional database. Transactional variables may include usage information, billing information, handset information, dropped call information, good call information, promotion information and rate plan information to name a few. Since the dimensions have known relationships to each other, such as rate plan and used minutes, the initial dimension choice for clustering is simplified. Additionally, the list of initial dimensions is further narrowed by insights from churn hypotheses, V-Factor analysis, or customer care call analysis.

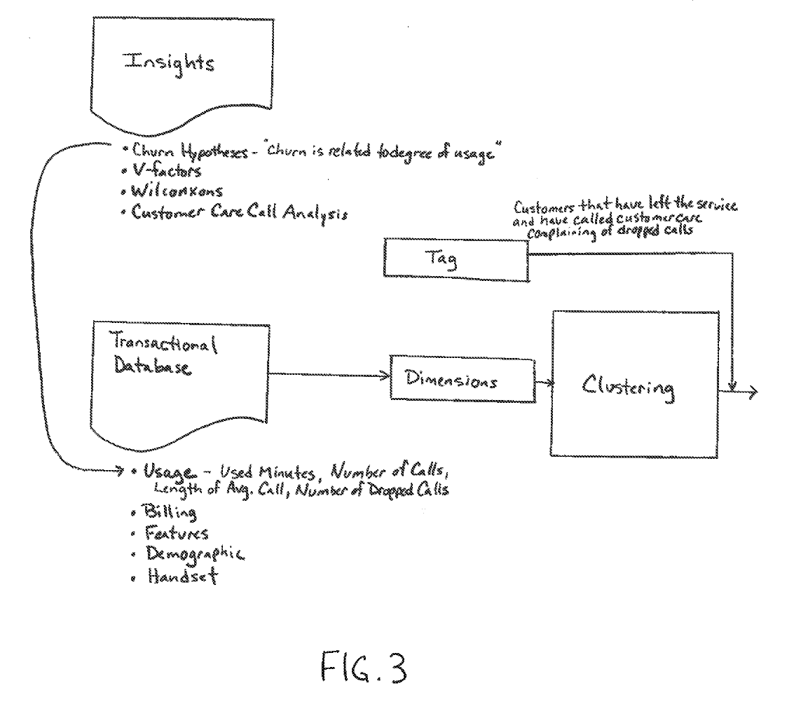

The first stage of IDC uses insights to narrow the number of dimensions to be used in the clustering algorithm from the plurality of dimensions to a set of initial dimensions. For example, a telecom provider hypothesizes that customer churn is related to the degree of usage. Dimensions are chosen from transactional variables related to usage information, such as ‘used minutes’, ‘number of calls made’, ‘length of average call’, ‘number of dropped calls’, etc. These dimensions become the space in which the algorithm clusters. The tag is defined from the customers having a known behavior, such as, for example, the individuals who have left the service, i.e. churned. The tag is then refined based upon insights from the larger population of customers within the telecommunications carrier data space. For example, there may be further information related to the tag, such as a specific reason through call center analytics customers are leaving, such that the tag can be further specified. For example, if call center analytics show that a specific group of customers are churning with complaints of dropped calls, this specific complaint becomes the tag. FIG. 3 illustrates the selection of initial dimensions based on data insights.

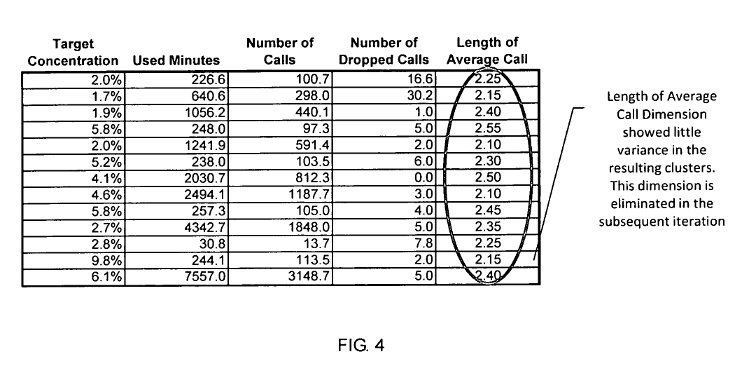

With the dimensions and the tag defined from insights from the transactional database and other sources of analysis, a clustering algorithm segments the population. The resulting clusters are analyzed to determine which dimensions have meaningful variance to the tag. Continuing from the example above, the dimensions ‘used minutes’, ‘number of calls’, and ‘number of dropped calls’ fluctuated in the clusters with varying concentrations of the tag. However, the variable ‘length of the average call’ did not have significant variance amongst the different concentrations of the tag. The dimensions are revised by removing the ‘length of the average call’ variable and the IDC process is repeated. FIG. 4 shows the results from the clustering, and the inconsequential variance in the ‘length of average call’ dimension between the clusters.

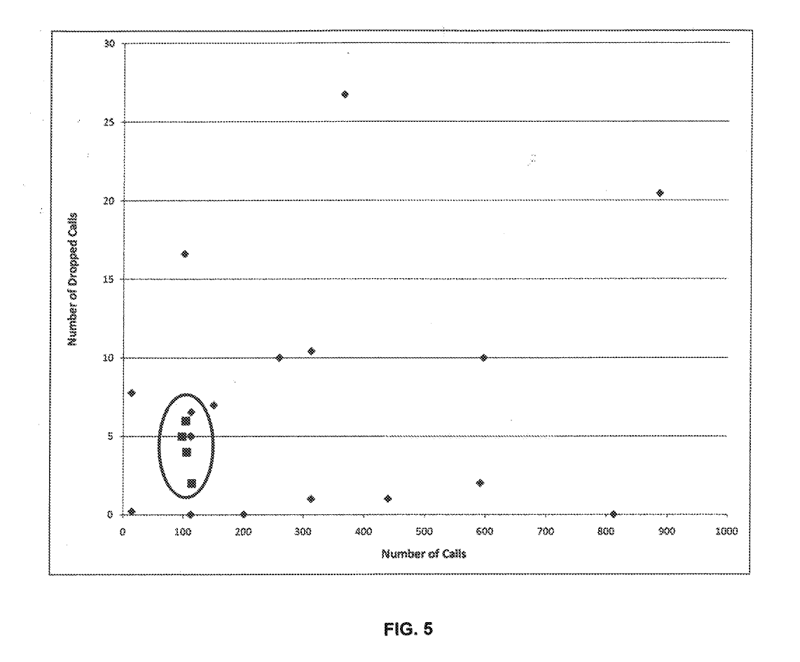

This process can be iterated several times, while each cycle analyzes the final concentration of the tags amongst the clusters. Due to the random nature of clustering, after refinement and repetition eventually common clusters arise that represent high concentrations of the tag. In the illustrated example, after several iterations, a consistent pattern evolves where customers that place approximately 100 calls/month and experience 1-5 dropped calls/month have an unusually high concentration of the tag (people with dropped calls that leave the service). FIG. 5 illustrates one example of a hot spot analysis, where the red clusters have a high concentration of churners.

With the target segments or target behavior identified, the non-tag customers within these groupings are deemed at a higher priority for action. Additionally, insight is known as to why these customers are targeted due to the tag/dimension relationship. Thus, high risk customers within these target segments can be made an offer that directly addresses the churn driver to prevent customer attrition. From this example, the tag was customers that left service and called customer care complaining of dropped calls. The customers within the targeted segments should be made an offer that directly addresses the issue of dropped calls, such as a higher quality handset.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects.

While the invention has been particularly shown and described with reference to various embodiments thereof, it will be understood by those skilled in the art that various other changes in the form and details may be made without departing from the spirit and scope of the invention.

We claim:

1. A computer-implemented method for identifying a segment of a population having a target behavior within a larger population within a data space using insights obtained from a population having known behavior, the method using a clustering algorithm, said method comprising:
identifying a plurality of dimensions to be used in the clustering algorithm;
narrowing the number of dimensions to be used in the clustering algorithm from a plurality of dimensions to a set of initial dimensions based upon analytics from various sources;
defining the tag from target behavior data within the data space from the population having a known behavior;
refining the tag based upon insights from the larger population within a data space;
segmenting the population within the data space into clusters using the clustering algorithm;
analyzing the resulting clusters for a high tag concentration; and
displaying the resulting clusters.

2. The computer implemented method of claim 1, wherein the analytics from various sources are chosen from a group consisting of V-factors, speech data, reports and familiarity with the data space.

3. The computer implemented method of claim 1, wherein said target behavior is a churn propensity flag.

4. The computer implemented method of claim 1, wherein the analysis of the resulting clusters for a high tag concentration comprises identifying the segment of a population having a target behavior so that the segment of the population can be acted upon to prevent the target behavior from happening.

5. The computer implemented method of claim 1, wherein the analysis of the resulting clusters for a high tag concentration comprises identifying the segment of a population having a target behavior so that the segment of the population can be acted upon to encourage the target behavior to happen.

6. The computer implemented method of claim 1, wherein the clustering algorithm is a naive k-nearest neighbor algorithm.

7. The computer implemented method of claim 6, wherein the distance metric is a weighted Euclidean distance.

8. The computer implemented method of claim 6, wherein the distance metric is a normalized dimension.

9. The computer implemented method of claim 1, further comprising the step of performing an iterative process to determine the identity of dimensions that are important to the tag and the identity of the segment of a population having a target behavior.

10. The computer implemented method of claim 9, wherein the iterative process further comprises eliminating dimensions that are shown to be insignificant in the step of analyzing the resulting clusters for a high tag concentration.

11. The computer implemented method of claim 10, further comprising refining the tag to be more specific.

12. The computer implemented method of claim 10, further comprising refining the tag to be more general.

13. The computer implemented method of claim 1, further comprising:
determining cluster variance for a particular dimension; and
eliminating the particular dimension in a subsequent iteration if the particular dimension results in little variance in the resulting clusters.

14. A computer-implemented method for identifying one or more customers having a target behavior within a larger population of customers within a telecommunication carrier data space using insights obtained from customers having known behavior, the method using a clustering algorithm, said method comprising:
identifying a plurality of dimensions to be used in the clustering algorithm from a plurality of transactional variables within a transactional database;
narrowing the number of dimensions to be used in the clustering algorithm from the plurality of dimensions to a set of initial dimensions;
defining the tag from the customers having a known behavior;
refining the tag based upon insights from the larger population of customers within the telecommunications carrier data space;
segmenting the population of customers within the data space into clusters using the clustering algorithm;
analyzing the resulting clusters for a high tag concentration so as to identify dimensions having a defined variance to the tag; and
displaying the resulting clusters.

15. The computer implemented method of claim 14, wherein the transactional variables are chosen from a group consisting of usage information, billing information, handset information, dropped call information, good call information, promotion information and rate plan information.

16. The computer implemented method of claim 14, wherein the step of narrowing the number of dimensions is based upon analytics from various sources.

17. The computer implemented method of claim 16, wherein the analytics from various sources are chosen from a group inclusive of churn hypothesis, V-factor analysis and customer care call analysis.

18. The computer implemented method of claim 14, wherein the known behavior is leaving the service of the telecommunication carrier.

19. The computer implemented method of claim 14, further comprising the step of performing an iterative process to determine the identity of dimensions that are important to the tag from the initial dimensions and the identity of the segment of a population having a target behavior.

20. The computer implemented method of claim 14 further comprising:
identifying the one or more customers having a target behavior from the relationship between the tag and the initial dimensions; and offering an action from the telecommunications carrier that addresses the target behavior.
